(19) United States
(12) Patent Application Publication
(10) Pub. No.: US 2007/0097069 A1
(43) Pub. Date: May 3, 2007

(54) Display driving circuit

(76) Inventors: Yoshiki Kurokawa, Tokyo (JP); Yasuyuki Kudo, Fujisawa (JP); Toshiyuki Kumagai, Chigasaki (JP); Goro Sakamaki, Fuchu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/546,250

(22) Filed: Oct. 12, 2006

(30) Foreign Application Priority Data
Oct. 13, 2005 (JP) 2005-298891
Jan. 19, 2006 (JP) 2006-011144
Aug. 25, 2006 (JP) 2006-228563

(51) Int. Cl. G09G 3/36

(52) U.S. Cl. 345/102

(57) ABSTRACT

In a display driving circuit according to the present invention, not all the pixel values (example : 0˜255) but only the values (example : 179˜255) of the significant partial range (N˜100%) have data of histogram of pixels of an image as a partial histogram, and when the pixel (Ds) at the significant t% rank order of the entire histogram is within the range of the partial histogram, the display driving circuit performs its operation in the same manner as in the case where it has the entire histogram, and when the pixel (Ds) is out of the range, the display driving circuit uses the range minimum value (N) in the place of the pixel of the significant t% rank order and performs its operation.

### CROSS-REFERENCE TO RELATED APPLICATION

The present application claims priority from Japanese Patent Application No. JP 2005-298891 filed on Oct. 13, 2005, Japanese Patent Application No. JP 2006-011144 filed on Jan. 19, 2006, and Japanese Patent Application No. JP 2006-228563 filed on Aug. 25, 2006, the contents of which are hereby incorporated by reference into this application.

### TECHNICAL FIELD OF THE INVENTION

The present invention relates to a display unit such as a liquid crystal display and the like and an art of a driving circuit thereof, more specifically, it relates to an art of the control of illumination and display in a display unit equipped with illumination means such as a backlight and the like.

### BACKGROUND OF THE INVENTION

In recent years, liquid crystal displays are loaded in battery driven information devices, for example cell phones and the like. Most of these displays are of transmissive types and semi transmission types that require backlights. At present, much of power consumption of liquid crystal displays is occupied by the power consumption of backlights. Therefore, efforts to reduce this power consumption of backlights are required. Especially, cell phones equipped with liquid crystal displays and the like require long-time battery driving with their liquid crystal displays operating for viewing video images of TV and the like.

As the efforts to reduce the backlight power consumption, there are methods disclosed in Japanese Patent Application Laid-Open No. H11-65531 and the like. For example, when a backlight emits light by 100%, and a front crystal liquid cell has an 80% transmission, what is seen is 80% of light. In this case, even though the backlight emits light by 100%, the light is reduced 20% by the liquid crystal cell. Meanwhile, when the backlight emits light by 80%, and the liquid crystal cell is made of 100% transmission, even though what is seen is 80% of the light, the light emission of the backlight can be restricted to 80%. By using these differences, the light emission amount and power consumption of the backlight is restricted.

Further, as the method of display control in relation with the backlight control, the histogram of image data (frequency distribution chart), that is the data showing the distribution of light and dark in a frame is used. For example, suppose there is a case where, in histogram data of pixel values (for example luminance values of 0˜255) of an image, pixels with luminance of 80% (luminance value=256×0.8≈205) take the largest luminance in the image. In this case, in displaying the image, as a control, the light emission ratio of the backlight is reduced four-fifths times as many as is own, i.e., from 100% to 80%, and by the reduction, all the pixel values of the display objective image is multiplied by five-quarters (125%). In other words, a control is made to suppress the backlight voltage and expand the pixel values of the display image. Thereby, it is possible to display the same image, at the same brightness as the original, with 80% of the backlight emission amount. The method to control the backlight and the display data in relation by use of the luminance maximum value in the histogram of image data in this manner is referred to as the first method.

Furthermore, in the first method, by use of the histogram, attention is focused on the pixels that are in the rank order of significant several % (t%) of the original display image data in luminance. Then suppose that this focused pixels portion has, for example 60% of luminance (luminance value=256×0.6≈134). In this case, in the same consideration as in the first method, the light emission amount of the backlight is restricted to 60%, i.e., three-fifths of it, and by this reduction, all the pixel values are multiplied by five-thirds (167%). Thereby, the same display image can be obtained. The method to use the luminance of the significant several % of the histogram as a standard in this manner is referred to as the second method. In this case, the display is available by a further smaller backlight emission amount than in the first method using the luminance maximum value. The t of the significant t% is the one to become the control standard value in the second method, and this t is referred to as the threshold value.

### SUMMARY OF THE INVENTION

With regard to the control of backlight and display data in the display unit, in the first method in the Japanese Patent Application Laid-Open No. 11-65531, since the backlight emission amount cannot be reduced much, it is desired to reduce the backlight emission amount much by use of the second method. However, in this second method, since it is necessary to hold all the data of histogram of an image for the control, the scale of the logic circuit for the histogram becomes large, and a hardware corresponding to the large scale is required. That is, it leads to the increased hardware scale and costs of the display unit. The logic circuit for the histogram is a circuit including a memory, and is structured of a counter circuit for counting, for example, the distribution of pixel values and the like.

Accordingly, the object of the present invention is to provide a display driving circuit wherein the control of backlight emission amount and display data by use of the histogram of pixels of the image is performed, thereby the backlight power consumption is reduced, and the reduction of hardware scale and costs of a display unit is realized. In other words, it is to provide a display driving circuit for realizing a backlight power saving function with a small logic amount (logic circuit scale), and keeping the display quality and realizing power saving especially in the case of such a display unit where the available hardware amount is strongly limited as a liquid crystal display for cell phone applications and the like.

In order to achieve the object, according to one aspect of the present invention, there is provided a display driving circuit (driver) that is loaded in a liquid crystal display unit and the like comprising illumination means such as a backlight or the like and a display panel, and displays and drives the display panel, and is marked by including the following technical means.

The present driver is equipped with means for acquiring a histogram (frequency distribution) of an image from display data, and control means (backlight power saving function) for controlling the brightness of the image by conversion of the display data with controlling the brightness of an illumination device using the histogram, on the basis of the control standard value (selection data value) in the range thereof. By the present control means, the power of the illumination device is reduced while the brightness of the display image is kept. The histogram herein shows the frequency distribution of respective display data in display data for single or a plurality of frames (single or a plurality of screens). Meanwhile, normally, one display data corresponds to one grayscale.

Accordingly, the present driver is not made into a structure equipped with a logic circuit that holds all the data of the histogram of pixels of an image for all the pixel values (for example, 256 grayscales of 0˜255) just like in the prior art, that is, calculates and stores the data of the histogram to all the pixel values (referred to as entire histogram). Instead, the present driver is made into a structure equipped with a logic circuit that holds the data to the values of a significant partial range (for example 179˜255) in the entire histogram data, that is, calculates and stores partial histogram data.

The limited histogram to be held for the values of the partial range (histogram data holding range) is referred to as a partial histogram. The histogram data holding range is determined, for example, in correspondence to the pixels (control standard values in the second method) of the rank order of the significant t% (first position) in the brightness of the image, so that for example the pixels of the first position should be included in the range sufficiently. The histogram data holding range is made the range of significant M% in the entire histogram of the pixel values of the image, in other words, the range of the lower limit N% (second position) ˜100% (0<M<100, 0<N<100, N=100−M). And, when the pixels (control standard values) at the first position of the histogram of the display objective image are contained in the partial histogram range, the driver is controlled and operated so that the same effect as that in the case where all the histogram data are held in the prior art (second method). Further, when the pixels at the first position of the histogram of the display objective image are out of the range, the driver is controlled and operated using the minimum value N of the partial histogram range (the value of the second position) in the place of the pixels at the first position.

The present driver has for example the following structure. The present driver includes histogram calculation means for obtaining a partial histogram on the basis of the input display data, and means that can perform correlately the expansion process of pixel values of the display data, and the process to restrict the light emission ratio of a backlight, on the basis of the calculated partial histogram data and the minimum value N and the like (the values of the second position) of the histogram data hold range and the control standard value (the value of the first position) and the like. In the present control, the selection data value (Ds) to become the present control standard value is determined from the partial histogram, the t, the minimum value N and the like. And, on the basis of the selection data value (Ds), and a table where the correlation of the control is described (voltage selection table) and the like, the driver determines a display data expansion coefficient (e), and a backlight voltage selection signal (Sv). In the table, relations of the selection data value (Ds), the display data expansion ratio, the backlight emission ratio and the like are described.

The present driver, with the display data value at the first position in the histogram in the input display data as the control standard value, includes first means (display data expansion processing circuit 216) that switches the brightness of the display image by the conversion such as expansion of the display data on the basis of the standard value, second means (voltage selection table 207 or the like) that switches the brightness of an illumination device by the control of the light emission ratio of the illumination device on the basis of the standard value, third means (histogram counting circuit 201) that detects and holds the histogram on the basis of the input display data, and control means (backlight control circuit 104) that increases the brightness of the display image by the first means with decreasing the brightness of the illumination device by the second means in correspondence thereto.

Accordingly, the objective (range) of detection and holding of the histogram in the third means is the partial range corresponding to the data from the most significant M%, to the lower limit N% in the values of the display data. Or, the range of the histogram may be the partial range corresponding to the data from the most significant (the brightest pixel) to the X-th rank pixel in the values of the display data.

Further, the control means, when the standard value is not contained in the partial range of the histogram, makes the standard value same as one corresponding to the lower limit value of N% or the X-th value and uses it.

Further, the present driver has means (system I/F, register or the like) that sets and changes the standard value (selection data value) and the value (t or the like) to determine that and the value (N or the like) to determine the partial range of the histogram, from external control means (control processor or the like) of the display driving circuit concerned. Moreover, the present driver has means that temporarily stops the use of the histogram in the control, and sets and changes the standard value, from the external control means of the display driving circuit concerned so as to substitute by a constant value (k).

Further, especially, the display panel is a liquid crystal panel, and the display unit is a liquid crystal display. The illumination device is a device that, when for example a single backlight is turned ON, illuminates roughly evenly from the backlight surface concerned to the liquid crystal panel. The second means changes the voltage applied to the backlight, thereby changes the light emission ratio of the ON state of the backlight.

Furthermore, the present driver includes a measuring circuit (histogram counting circuit 201) that calculates the histogram about the display data for one or a plurality of screens inputted from the outside, in a display driving circuit that outputs the voltage corresponding to the display data inputted from the outside to the display panel, and detects the selection data value (Ds) of the histogram corresponding to a specified display data (the t or the like) so as to obtain the control standard value, a converting circuit (display data expansion processing circuit 216) that converts the display data for one or a plurality of screens, according to the selection data value (Ds), a generating circuit (grayscale voltage generating circuit 107) that generates a plurality of voltages according to the values of the plurality of display data, a selecting circuit (source line driving circuit 108 or the like) that selects voltage according to the display data after the conversion from the plurality of voltages, and a setting circuit (control register 103 or the like) that sets the range to measure the histogram.

Moreover, in the present driver, the measuring circuit, when the selection data value (Ds) is out of the range of the histogram set by the setting circuit, detects the value of the border of the range of the histogram (the value corresponding to the N or the like), and the converting circuit converts the display data for the one or a plurality of screens according to the value of the border. Further, the display panel has an illumination device such as a backlight for illuminating pixels. And, the present driver controls the voltage applied to the illumination device or the light emission amount of the illumination device, according to the selection data value (Ds) of the histogram.

The effects obtained by typical aspects of the present invention will be briefly described below. According to the present invention, the backlight emission amount and the display data are controlled by use of the histogram of pixels of the image, and thereby, it is possible to reduce the backlight power consumption, and realize the reduction of the hardware scale and costs of the display unit. In other words, it is possible to realize the backlight power saving function with a small logic amount (logic circuit scale). And it is possible to keep the display quality and realize power saving especially in the case of such a display unit where the available hardware amount is strongly limited as a liquid crystal display for cell phone applications and the like.

### BRIEF DESCRIPTIONS OF THE DRAWINGS

FIG. 1 illustrates a structure of a block of a liquid crystal driver according to a first embodiment of the present invention and the peripheral thereof;

FIG. 2 illustrates a detailed structure of a backlight control circuit and processing method in the liquid crystal driver according to the first embodiment of the present invention;

FIG. 3A illustrates a partial histogram and a processing method, in a backlight power saving function using a histogram in the liquid crystal driver according to the first embodiment of the present invention;

FIG. 3B illustrates a partial histogram and a processing method, in a backlight power saving function using a histogram in the liquid crystal driver according to the first embodiment of the present invention;

FIG. 3C illustrates a partial histogram and a processing method, in a backlight power saving function using a histogram in the liquid crystal driver according to the first embodiment of the present invention;

FIG. 3D illustrates a partial histogram and a processing method, in a backlight power saving function using a histogram in the liquid crystal driver according to the first embodiment of the present invention;

FIG. 4A is a control flowchart illustrating a processing method about a range minimum value (N), in a backlight power saving function using a histogram in the liquid crystal driver according to the first embodiment of the present invention;

FIG. 4B is a control flowchart illustrating a processing method about a range minimum value (N), in a backlight power saving function using a histogram in the liquid crystal driver according to the first embodiment of the present invention;

FIG. 5 illustrates a structure of a block of a liquid crystal driver according to a second embodiment of the present invention and the peripheral thereof;

FIG. 6 illustrates a schematic structure of illumination and display by a backlight and a liquid crystal panel in a liquid crystal driver according to an embodiment of the present invention;

FIG. 7 illustrates details of a histogram counting circuit in a liquid crystal driver according to a third embodiment of the present invention;

FIG. 8 illustrates a relation between gamma values and entry data in the liquid crystal driver according to the third embodiment of the present invention;

FIG. 9 describes the actions of the histogram counting circuit in the liquid crystal driver according to the third embodiment of the present invention;

FIG. 10 illustrates the details of a histogram counting circuit in a liquid crystal driver according to a fourth embodiment of the present invention;

FIG. 11 illustrates a detailed structure of a backlight control unit and a processing method thereof in a liquid crystal driver according to a fifth and sixth embodiments of the present invention;

FIG. 12 illustrates a detailed structure of a selection data value calculating unit using an APL and a maximum value in the liquid crystal driver according to the fifth embodiment of the present invention;

FIG. 13 illustrates a detailed structure of a selection data value calculating unit using a minimum value and a maximum value in the liquid crystal driver according to the sixth embodiment of the present invention.

FIG. 14 illustrates the actions of a histogram counting circuit in a liquid crystal driver according to a seventh embodiment of the present invention.

FIG. 15A describes hysteresis change of coefficient output of the histogram counting circuit in the liquid crystal driver according to the seventh embodiment;

FIG. 15B describes hysteresis change of coefficient output of the histogram counting circuit in the liquid crystal driver according to the seventh embodiment;

FIG. 16 illustrates the details of a histogram counting circuit in a liquid crystal driver according to an eighth embodiment of the present invention;

FIG. 17 is an illustration for explaining the fluctuation amount limitation of coefficient output of a histogram counting circuit in the liquid crystal driver according to the eighth embodiment of the present invention;

FIG. 18 illustrates a structure of a block in a liquid crystal driver according to a ninth embodiment of the present invention and the peripheral thereof; and

FIG. 19 is a figure showing a structure of a block in a liquid crystal driver according to a tenth embodiment of the present invention and the peripheral thereof.

### DESCRIPTIONS OF THE PREFERRED EMBODIMENTS

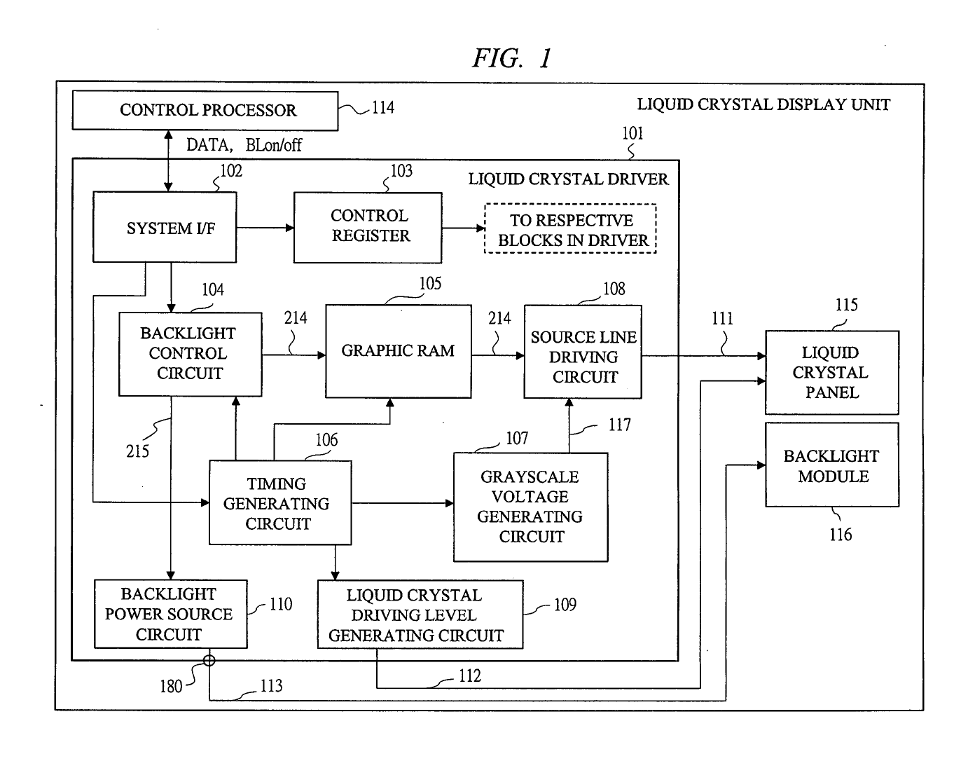

Hereinafter, embodiments of the present invention will be described in detail with reference to the accompanying drawings. Note that components having the same function are denoted by the same reference symbols throughout the drawings for describing the embodiment, and the repetitive description thereof will be omitted. FIG. 1 through FIG. 19 are for explaining the embodiments.

In the embodiments described below, in a liquid crystal driver equipped with a liquid crystal display unit having a backlight module and a liquid crystal panel, means for controlling the backlight emission ratio and the display data expansion using the histogram data of pixels of a display objective image is provided as a backlight power saving function. In the present driver, data is held according to the significant partial range of the entire histogram, thereby the power saving function is realized so that the necessary logic circuit scale should be small.

### First Embodiment

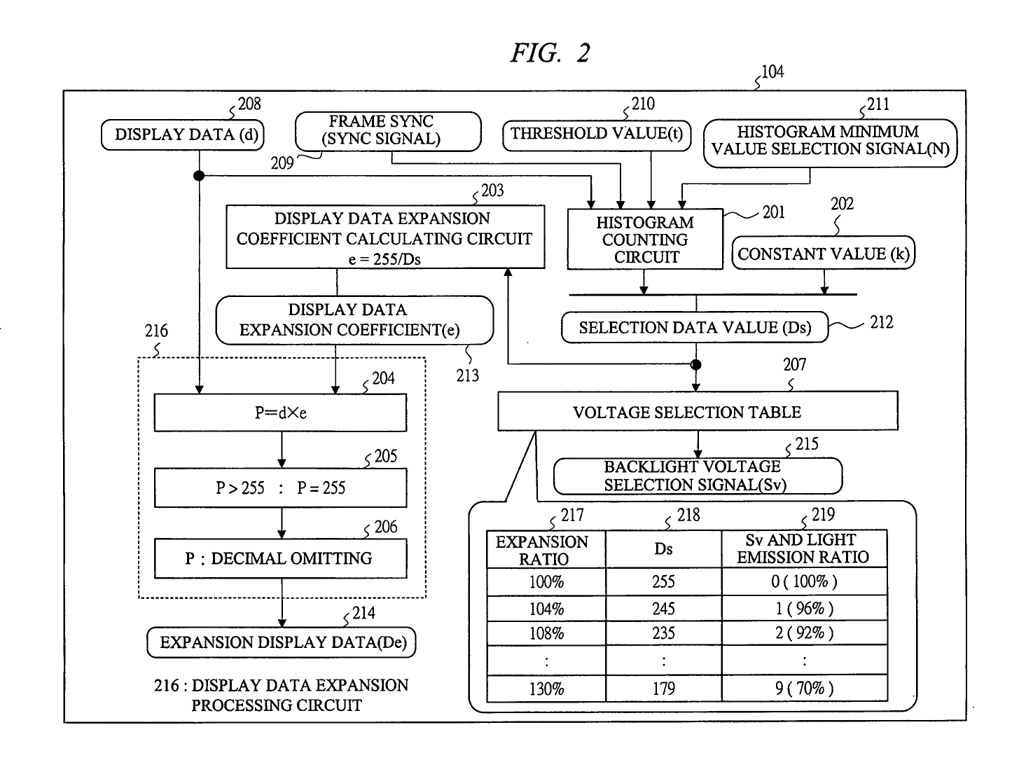

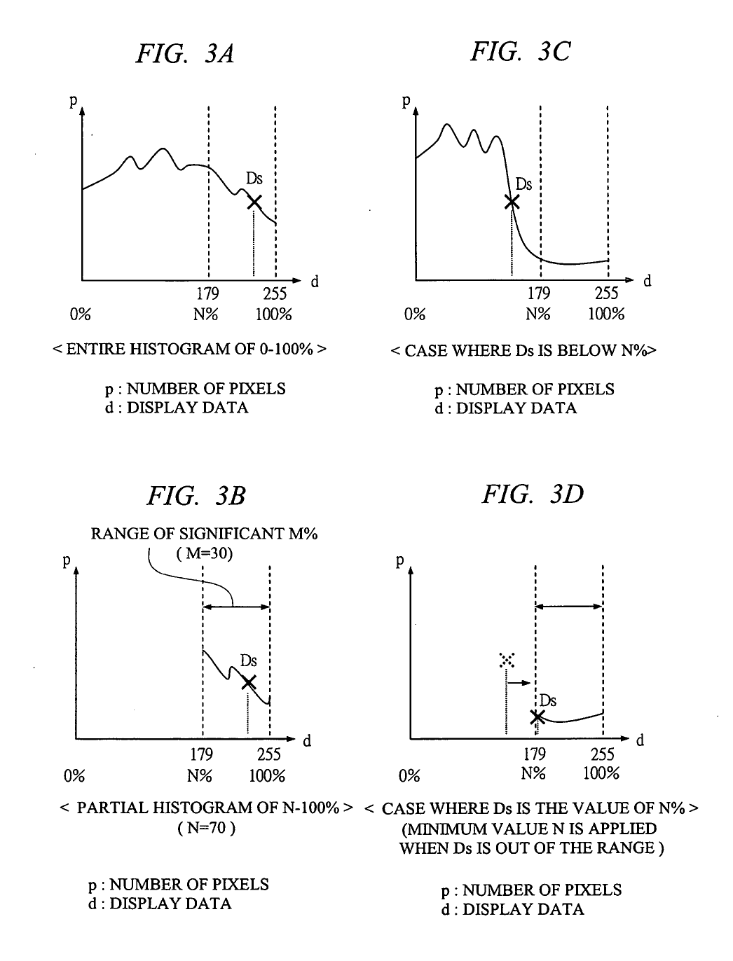

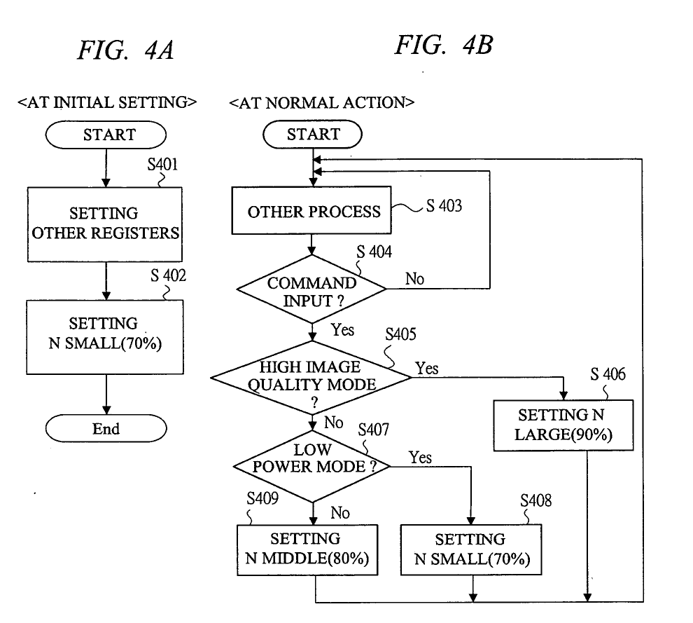

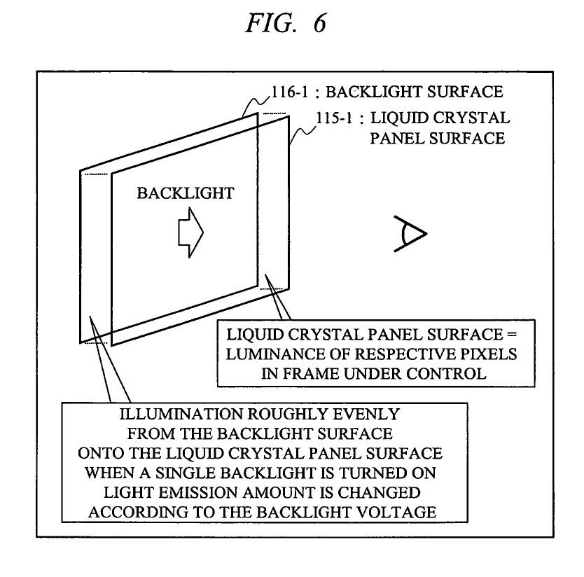

FIG. 1 shows a structure of a liquid crystal display unit including a liquid crystal driver 101 and the peripheral thereof according to a first embodiment. FIG. 2 shows a structure and processing of a backlight control circuit 104 in the liquid crystal driver 101. FIG. 3 shows a processing by use of a partial histogram as the characteristic control in the liquid crystal driver 101. FIG. 4 shows a control processing flowchart in the liquid crystal driver 101. FIG. 6 shows a schematic structure of illumination and display by a backlight in the present liquid crystal display unit.

In FIG. 1, the present liquid crystal display unit has a structure including a control processor 114, a liquid crystal driver 101, a liquid crystal panel 115, and a backlight module 116. The control processor 114 controls the entire liquid crystal display unit including the liquid crystal driver 101. The present liquid crystal display unit is a liquid crystal display or the like to be loaded in for example a cell phone. The liquid crystal driver 101 drives the display by supplying a voltage corresponding to the display data to the liquid crystal panel 115, and supply the voltage to the backlight module 116 and thereby controls the illumination thereof. In the liquid crystal panel 115, the luminance thereof is controlled in unit of pixel (display cell) by voltage supply to respective signal lines. The backlight module 116 is arranged at the rear side of the liquid crystal panel 115, and illuminates toward the front side of the liquid crystal panel 115 by a backlight (electric light). The light of the backlight is transmitted according to the respective liquid crystal cell states of the liquid crystal panel 115.

Meanwhile, a backlight power source circuit 110 supplies power to the backlight module 116, and a power source circuit not illustrated therein supplies power to other portions. Further, the present liquid crystal display unit has the control processor 114, but the control processor 114 may be connected externally.

The liquid crystal driver 101 main body has internal blocks shown by 102 through 110. The liquid crystal driver 101 has a structure including a system I/F (interface) 102, a control register 103, a backlight control circuit 104, a graphic RAM (image memory) 105, a timing generating circuit 106, a grayscale voltage generating circuit 107, a source line driving circuit 108, a liquid crystal driving level generating circuit 109, and a backlight power source circuit 110.

The system I/F 102 is the system interface unit (circuit) of the liquid crystal driver 101, and performs communications with the control processor 114 at the outside. The system I/F 102 delivers display data (DATA), write data (set values) to the control register 103 for controlling the respective portions of the liquid crystal driver 101 and the like, from the outside of the liquid crystal driver 101 (control processor 114) to the respective blocks in the inside. The control register 103 is a set of registers that control the respective portions of the liquid crystal driver 101.

The backlight control circuit 104 is a block that mainly performs the control corresponding to the characteristics of the present invention. The backlight control circuit 104 receives the display data from the system I/F 102, and performs a display data expansion processing to be described later herein. And it transfers the display data processed thereby (expansion display data 214 to be described later herein) to the graphic RAM 105. Further, the backlight control circuit 104 performs a backlight emission ratio control to be described later herein. And it sends the signal (light voltage selection signal 215 described later herein) for controlling the voltage of the backlight power source (power source of the backlight module 116) to the backlight power source circuit 110 thereby. The backlight emission ratio control and the display data expansion process are mutually related controls, and control the brightness of the display image after control so as to become same as that of the image before control.

The graphic RAM 105 performs the role as a buffer that receives and stores the display data, and, delivers the display data to the source line driving circuit 108. The timing generating circuit 106 generates the action timing of the entire driver 101 on the basis of the contents of the control register 103, and supplies the timing signal to the respective portions of the backlight control circuit 104 and others. The grayscale voltage generating circuit 107 generates the grayscale voltage to be used by the source line driving circuit 108, in correspondence to the grayscale level of the display data. The source line driving circuit 108 selects a specified voltage among the grayscale voltages from the grayscale voltage generating circuit 107 according to the display data coming from the graphic RAM 105, and outputs it as a liquid crystal source signal (corresponding to a data line) 111 to the liquid crystal panel 115 of the outside. The liquid crystal driving level generating circuit 109 generates a liquid crystal gate signal and a common signal (corresponding to a scan line) 112 to be used for driving the liquid crystal, and outputs them to the liquid crystal panel 115 of the outside.

The backlight power source circuit 110 generates a desired voltage on the basis of the information from the backlight control circuit 104, and supplies it to the backlight power source line 113. The backlight power source line 113 supplies the backlight voltage to the backlight module 116. Further, the backlight power source circuit 110 receives a command to turn on(ON)/turn off(OFF) the backlight from the control register 103, and generates the voltage for turning ON/OFF the backlight, and supplies it to the backlight power source line 113. In the backlight module 116, according to the backlight voltage of the backlight power source line 113, the backlight emission, and backlight ON/OFF are performed.

At the outside of the liquid crystal driver 101, the control processor 114 generates the display data (DATA) and the like, and transfers them to the liquid crystal driver 101 via the system I/F 102. Further, the control processor 114 can give various commands such as the command of the backlight ON/OFF control (shown by BL on/off) and the like, to the liquid crystal driver 101. The liquid crystal panel 115 receives the liquid crystal source signal 111 and the liquid crystal gate signal and the common signal 112 from the liquid crystal driver 101 and displays them. Further, the backlight module 116 receives power from the liquid crystal driver 101 via the backlight power source line 113, and turns on the backlight at a desired brightness according to the backlight voltage, and illuminates the entire liquid crystal panel 115. Thereby, a user can see the display of the liquid crystal panel 115 as visible light.

FIG. 6 shows the outline of illumination and display in the present embodiment. A backlight surface 116-1 of the backlight module 116, and a liquid crystal panel surface (display screen) 115-1 of the liquid crystal panel 115 are roughly overlapped. Illumination is made roughly evenly from the backlight surface 116-1 to the liquid crystal panel surface 115-1. Illumination is made in a single backlight ON state in the backlight module 116. The backlight emission amount changes according to the backlight voltage. Further, by the ON/OFF operation of the backlight voltage, the backlight ON/OFF can be controlled. The luminance of respective pixels in the liquid crystal panel surface 115-1, that is, a frame (image) is controlled according to the display data.

The liquid crystal driver 101 works as described below, by use of the respective blocks mentioned above. The liquid crystal driver 101 takes in the display data (DATA) via the system I/F 102 from the control processor 114 of the outside, and transfer the data to the backlight control circuit 104. In the backlight control circuit 104, the display data expansion processing to be described later herein is performed, and the data is accumulated into the graphic RAM 105. In the timing generating circuit 106, the read timing of the graphic RAM 105 is generated, and at the timing the display data is transferred to the source line driving circuit 108. The source line driving circuit 108 selects a voltage by the display data from the grayscale voltages generated by the grayscale voltage generating circuit 107, and outputs the voltage as the liquid crystal source signal 111 to the liquid crystal panel 115. Further, by use of the timing generated by the timing generating circuit 106, the liquid crystal driving level generating circuit 109 generates the liquid crystal gate signal and common signal 112, and outputs these to the liquid crystal panel 115 too. By the respective signals from the liquid crystal driver 101, the respective cells of the liquid crystal panel 115 are driven.

Further, by the information from the backlight control circuit 104, the backlight power source circuit 110 generates a voltage, and applies it to the backlight power source line 113. Thereby the backlight module 116 is turned on (or off). The backlight that is turned on in the backlight module 116 illuminates the liquid crystal panel 115, thereby the user can view the display. Further, when the backlight ON/OFF operation is made from the control processor 114, information for the control is written via the system I/F 102 to the control register 103. And, the information is sent to the backlight power source circuit 110, and the backlight power source circuit 110 generates the voltage according to the backlight ON/OFF, and applies this to the backlight power source line 113, as a result, it turns ON/OFF the backlight of the backlight module 116. Meanwhile, the operation of this backlight ON/OFF from the control processor 114 has priority over the control operation of the backlight power saving function. That is, the backlight ON/OFF control signal has priority over the signal for controlling the voltage of the backlight power source which the backlight control circuit 104 generates (backlight voltage selection signal 215).

Further, the liquid crystal driver 101 has a terminal 180 to which the backlight power source line (backlight voltage) 113 to the backlight module 116 is connected, at the rear stage of the backlight power source circuit 110. In the prior art, when the backlight module system and the liquid crystal driver are independent and not connected, for the control of the backlight emission, other control circuit than the liquid crystal driver is required. In the present embodiment, the terminal 180 is arranged and the liquid crystal driver 101 and the backlight module 116 are connected with each other, thereby a direct control is available.

Next, with reference to FIG. 2, the operation in the backlight control circuit 104 is explained hereinafter. The backlight control circuit 104 includes a histogram counting circuit 201, a voltage selection table 207, a display data expansion coefficient calculating circuit 203, a display data expansion processing circuit 216 and the like.

The histogram counting circuit 201 inputs display data (d) 208 and calculates it, and creates and holds the histogram data of pixel value of a display objective image. What is created and held herein is the data of the partial histogram. And, the backlight control circuit 104 calculates, from the data of the partial histogram, a selection data value (Ds) 212 to be used for controlling the backlight emission ratio. It sends the calculated selection data value (Ds) 212 to the display data expansion coefficient calculating circuit 203, and the voltage selection table 207.

With regard to the selection data value (Ds) 212, it is determined what number data value from the significant in the histogram is to be used by use of the threshold value (t) 210, and it is checked in which entry in the histogram this determined rank order data exists, and the value of the entry where it exists is calculated as a data value. This selection data value 212 is one of the standard values for the control in the display data expansion processing and the backlight reduction processing. From the value of the selection data value 212, the display data expansion coefficient (e) 213 is calculated and the magnifying power of data expansion is determined, and the backlight voltage selection signal 215 is generated, and thereby the brightness of the illumination of the backlight is determined.

The-selection data value (Ds) 212 is, as described above, calculated in correspondence to the value of the pixel of the significant t% (t: threshold value 210) of the pixel value of the display data 208. Meanwhile, attention must be paid to the fact that the selection data value (Ds) 212, the threshold value (t) 210, the histogram minimum value selection signal (N) 211 and the like are different respectively.

A frame SYNC (sync signal) 209 is a control signal which the histogram counting circuit 201 uses so as to work per frame (image). The histogram counting circuit 201, when the frame SYNC 209 is off, continues registering (counting) the sent display data (d) 208 to the partial histogram, and at the timing when the frame SYNC 209 is ON, it calculates the selection data value 212, and clears the partial histogram, and prepares for the data calculation of the next frame.

The threshold value (t) 210 is a parameter that determines what number or what % data of the significant in the histogram is used as described previously, and is used for the calculation of the selection data value 212.

The histogram minimum value selection signal (N) 211 (hereinafter, referred to as range minimum value (N) and the like), when using a part of the significant in the entire histogram as a partial histogram, determines the range of the use (N˜100%) by this value. Meanwhile, not N representing the lower limit of the range, but M representing the width of the range may be employed too. The value of the histogram minimum value selection signal (N) 211 corresponds to N in FIG. 3 to be described later herein. This value (N) is made into a structure whose settings can be changed by the user, and is used as below. For example, when high quality in display is to be kept (that is, when the image quality has priority over power saving), this value (N) is made large and the range of the partial histogram is narrowed, thereby the image quality deterioration is prevented. Further, when power saving has priority over image quality, this value (N) is made small and the range of the partial histogram is widened, thereby the emission of the backlight is restricted and power is reduced.

A constant value (k) 202 is used in the case when the control using the partial histogram or the entire histogram as shown in the present embodiment is not used. In this case, irrespective of the contents of the display data, the selection data value (Ds) 212 is handled as a fixed value corresponding to the constant value (k) 202.

In the display data expansion coefficient calculating circuit 203, by use of the selection data value (Ds) 212, a calculation e=255/Ds is performed, that is, a calculation of dividing the pixel value maximum value (grayscale level maximum value) by the selection data value (Ds) 212 is performed, thereby the display data expansion coefficient (e) 213 is calculated.

The display data expansion processing circuit 216 performs the processing to expand the display data by blocks of an expansion calculating circuit 204, a saturation calculation processing circuit 205, and a decimal omitting circuit 206, and thereby obtains an expansion display data (De) 214. First, in the expansion calculation circuit 204, the input display data (d) 208 is multiplied by the display data expansion coefficient (e) 213 (P=d×e). Next, in the saturation calculation processing circuit 205, a saturation calculation is performed where if the result (P) of the multiplication exceeds 255, the result is made 255. Finally, in the decimal omitting circuit 206, decimals of the P are omitted, and the result is outputted as the expansion display data (De) 214.

The voltage selection table 207 selects and outputs the backlight voltage selection signal (Sv) 215 by use of the table contents, on the basis of the selection data value (Ds) 212. One structural example of the voltage selection table 207 is shown in the lower portion of FIG. 2. In the voltage selection table 207, the column of the expansion ratio 217 shows the expansion ratios of pixels from the original display data (d) 208 to the expansion display data (De) 214. The column of Ds 218 shows the case where the value of the selection data value (Ds) is in the range 0˜255 of data value in 256 grayscales. The column of Sv and light emission ratio 219 shows the value of the backlight voltage selection signal (Sv) 215, and, the corresponding light emission ratio in parentheses. The present example shows the case where the light emission ratio is in the range 70˜100% (that is, N=70, M=30), and relatively, the expansion ratio is in the range 100˜130%. Meanwhile, the present invention is not limited to the method to hold such a table (207), but a structure where calculation is made at necessity by a simple calculation equation may be used.

Meanwhile, the threshold value (t) 210, the histogram minimum value selection signal (N) 211, the constant value (k) 202 and other values are set from the control processor 114 to the control register 103, and these values are used. The present invention is not limited to this, but a structure where a fixed value is set inside of each portion beforehand may be employed.

The entire flow of actions is as described below. Mainly with the backlight control circuit 104, the display data (d) 208 is counted per frame by the histogram counting circuit 201, and as needed, the partial histogram is obtained. From the result, the selection data value (Ds) 212 is obtained. In the display data expansion coefficient calculating circuit 203, the display data expansion coefficient (e) 213 is calculated, and by use of this and the display data (d) 208, the expansion display data (De) 214 is outputted by the display data expansion processing circuit 216. On the other hand, from the selection data value (Ds) 212, by use of the voltage selection table 207, the backlight voltage selection signal (Sv) 215 is outputted. Between the expansion display data (De) 214 and the backlight voltage selection signal (Sv) 215 obtained by these control actions, there is established the relation shown in the voltage selection table 207.

In the voltage selection table 207, when the expansion ratio 217 changes like 100%, 104%, 108%, . . . , 130% against the display data (d) 208, in the Sv and the light emission ratio 219, the voltage decreases at the same rate like 0 (100%), 1 (96%), 2 (94%), . . . , 9 (70%). As the result of the present control described above, the brightness of the output of the final image does not change in comparison with the case where the present control is not performed, that is, it is roughly same.

Further, when the constant value (k) 202 is used, the selection data value (Ds) 212 is made constant irrespective of the contents of the display data (d) 208, as a result, the display data expansion coefficient (De) 213 and the backlight voltage selection signal (Sv) 215 become constant values too. The display data (d) 208 becomes the expansion display data (De) 214 multiplied by a constant multiplying power. Accordingly, in this case, the brightness of the entire image does not change while video image is displayed, and blink and flicker of video image are prevented, and the present invention can be effectively used for the case where high image quality is desired according to images.

Next, with reference to FIG. 3, it is explained that in the present embodiment, the histogram of the histogram counting circuit 201 is not required to be held in response to all the range (0˜255) of the display data, but it is required to be held only to a part thereof.

FIG. 3A shows the case of the prior art having the entire histogram of luminance 0˜100% in the distribution of the luminance of pixels of image display data. The place of the selection data value (Ds) 212 is shown by a mark X. It is a case where each pixel value takes 0˜255. The reference d of the horizontal axis is the value (entry) of the display data (d) 208, and the reference p is the number of pixels (number of registration) corresponding to d. Meanwhile, in the present example, luminance data is handled as the values of respective pixels, but the data format is not limited to this.

FIG. 3B is the case having a partial histogram corresponding to the significant M% range, that is, N˜100% portion in the distribution of luminance. N and M are values existing in the range 0˜100 (although it depends on the display data contents, values 70˜90 are especially efficient). In FIG. 3, the case where N=70, M=30 is shown. Meanwhile, the value of the display data (d) 208 corresponding to N=70% is 179. In the case of FIG. 3B, the mark X showing the selection data value (Ds) 212 is between N% and 100%, and the place of the selection data value (Ds) 212 can be shown in the same manner as in the case of FIG. 3A, and accordingly, there is no problem with the control as in the prior art.

FIG. 3C shows another case where, in the case having the entire histogram as in FIG. 3A, the place of the selection data value (Ds) 212 is lower than the lower limit N% of the partial range.

FIG. 3D shows the case where, since the selection data value (Ds) 212 is out of the partial range like in FIG. 3C, the control standard value is handled as N% as the range minimum value, that is, the case where the selection data value (Ds) 212 becomes the value corresponding to N%. Thereby, in the case having only the partial histogram like the present embodiment, there exists an adverse effect that the selection data value (Ds) 212 becomes a bit larger than the prior case having the entire histogram (error by counting up to N). However, also in this case, sufficient effects as the backlight power saving function using the histogram can be attained. Further, as described previously, the structure is made so that the N (histogram minimum value selection signal 211) and the like can be changed, that is, their settings can be made by the control register 103 and the like. Thereby, in the case to keep high image quality, the value (N) is made large (for example, 90), and thereby image quality deterioration is prevented, and further, when to prefer power saving to image quality, the value (N) is made small (for example, 70), the backlight emission is restricted, thus, it may be used according to the display data and user selections.

Meanwhile, in the present example, the processing is made by Percentage Units (%) as the portion over N% is used with the maximum value of the display data 208 as 100%, however, the processing may be made by use of the numeric value of the display data 208 and the rank order thereof. For example, the maximum value of the display data may be set to 255, and the partial histogram over X (X being an integer in the relation 0<X<255) may be used. That is, the partial range corresponding to the data from the most significant (brightest pixel) to the X-th rank order in the distribution of lights and darks in the display data may be used.

Next, with reference to FIG. 4, concerning the lower limit value N of the partial histogram, one example of the setting method and the like are shown hereinafter. The process of the present flow is operated on the control processor 114 in FIG. 1, and the process is made to the liquid crystal driver 101. Various settings are made to the control register 103. The present process is a process in a structural example which can be changed for respective modes corresponding to the display image quality priority and the power saving priority described previously, and intermediate mode that is not both of them. FIG. 4A is a flowchart at initial setting. After start, at S401, other register setting necessary for liquid crystal display (conventional setting other than the setting of N and the like) is performed. And, at S402, the initial set value of N is set to a small value (70%). This is an example, and the initial set value of N may be made larger.

FIG. 4B is a flowchart at normal action. After start, at S403, other processes are made, and at S404, it is judged whether there is input of command from the user or the like, and if there is no input, the procedure goes back to S403. If there is a command input, at S405, it is judged whether the command shows switching to high image quality mode. As a result, when switching to the high image quality mode is designated, at S406, the value of N is set to be larger than the initial value (90%), and the procedure goes back to S403. When the high image quality mode is not designated, at S407, it is judged whether the command shows switching to low power mode, and as the result, when the low power mode is designated, at S408, the value of N is set to be small (70%), and the procedure goes back to S403. If the mode is not the low power mode either, it is the intermediate mode, and at S409, the value of N is set to be middle level (80%), and the procedure goes back to S403. By these controls, even in the normal action, N can switched dynamically by command input, and use at the mode the user desires is available.

According to the present embodiment, the histogram data to be held can be structured by only the value of the significant partial range, and the scale of the necessary logic circuit can be reduced accordingly. For example, when the pixel value of an image uses the range 183˜255, it can be made into the size of approximately 30% of the conventional size. Further in the actual display image, the light emission amount to be reduced is considered to correspond to the histogram of the significant 30% range, and if there is a detecting circuit for this amount, that is, the histogram counting circuit 201, sufficiently effective effects not so different from the case where the entire histogram is held like in the prior art can be attained.

### Second Embodiment

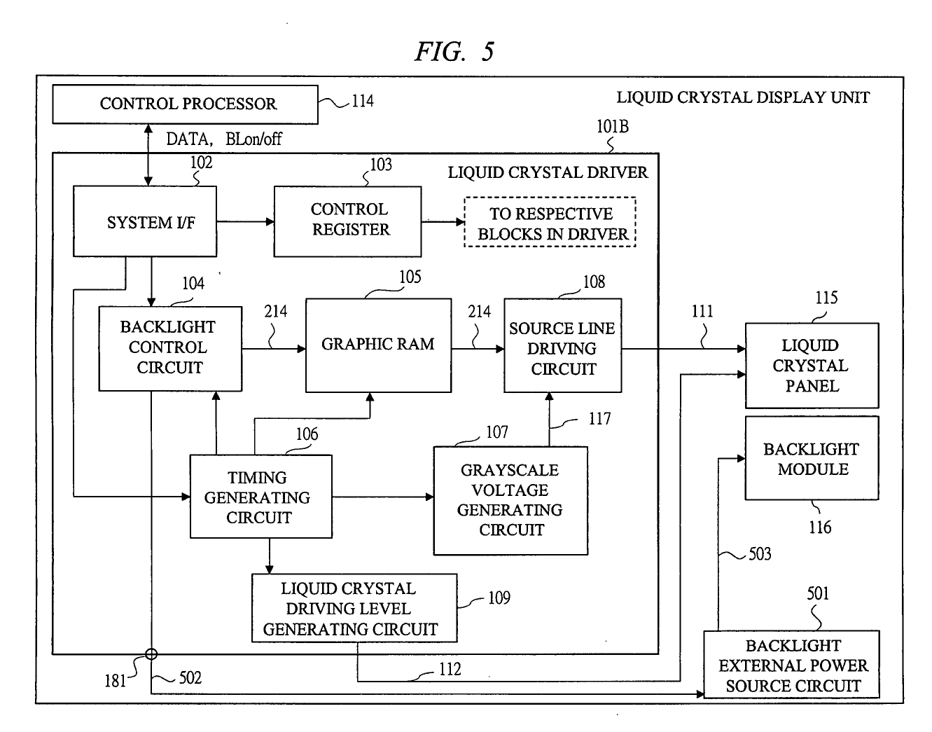

Next, a second embodiment is explained hereinafter. FIG. 5 shows a structure of a liquid crystal display unit including a liquid crystal driver 101B and the vicinity thereof according to the second embodiment. In comparison with the first embodiment, the backlight power source circuit 110 is not arranged inside of the liquid crystal driver 101B, instead, a backlight external power source circuit 501 having the function equivalent to that of the backlight power source circuit 110 is arrange outside of the liquid crystal driver 101B, and inside of the liquid crystal display unit. It outputs a backlight control signal 502 (corresponding to the backlight voltage selection signal 215) from the liquid crystal driver 101B, and thereby controls the backlight external power source circuit 501 in the same manner as in the first embodiment. The control itself of the backlight power saving function is same as that in the first embodiment.

As the action, by the information from the backlight control circuit 104, the backlight control signal 502 is generated, and sent to the backlight external power source circuit 501. The backlight external power source circuit 501, on receiving the backlight control signal 502, generates a desired voltage (including backlight ON/OFF voltage), and applies it to the backlight power source line 503. According to the backlight voltage of the backlight power source line 503, the backlight module 116 turns on (or off) the backlight. Further, when the backlight is turned ON/OFF from the control processor 114, the information is written via the system I/F 102 to the control register 104, and this is transmitted to the backlight control circuit 104. And the backlight control circuit 104 sends the backlight control signal 502 for generating the ON/OFF voltage, and the backlight external power source circuit 501 that has received this generates the backlight ON/OFF voltage, and applies it to the backlight power source line 503, as a result, the backlight of the backlight module 116 is turned ON/OFF.

Further, the liquid crystal driver 101B has a terminal 181 to which the signal line of the backlight control signal 502 to the backlight external power source circuit 501, at the rear stage of the backlight control circuit 104.

### Third Embodiment

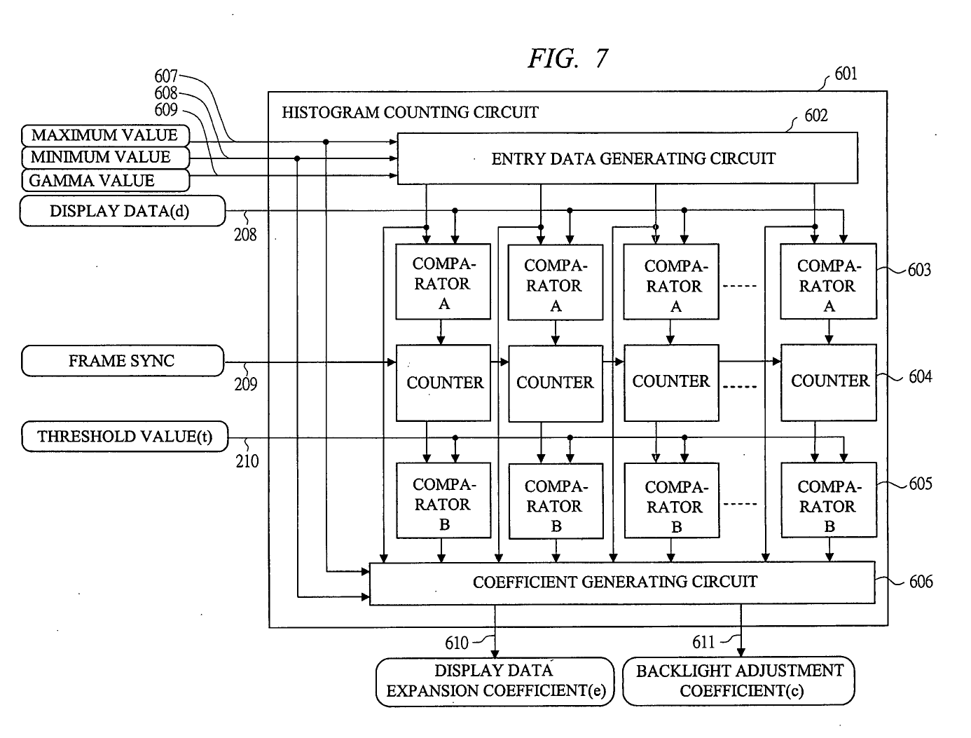

Next, a third embodiment is explained with reference to FIG. 7 through FIG. 9 hereinafter. In the above first embodiment, the histogram data to be held can be structured not to all the pixel values (0˜255) but to only the values of the significant partial range (for example, 183˜255), and the scale of the necessary logic circuit is reduced accordingly, thereby the backlight emission amount control for practical use is realized. In a liquid crystal driver according to the third embodiment, further, the upper limit of the histogram hold objective is not fixed to 255 (pixel value), but both the upper limit and the lower limit are set, thereby the control is made more flexible. Further more, the embodiment can easily cope with a display having different gamma curves.

FIG. 7 shows a block structure of a histogram counting circuit 601 (circuit corresponding to the 201) in the third embodiment. The histogram counting circuit 601 has an entry data generating circuit 602, plural comparators A 603, plural counters 604, plural comparators B 605, and a coefficient generating circuit 606.

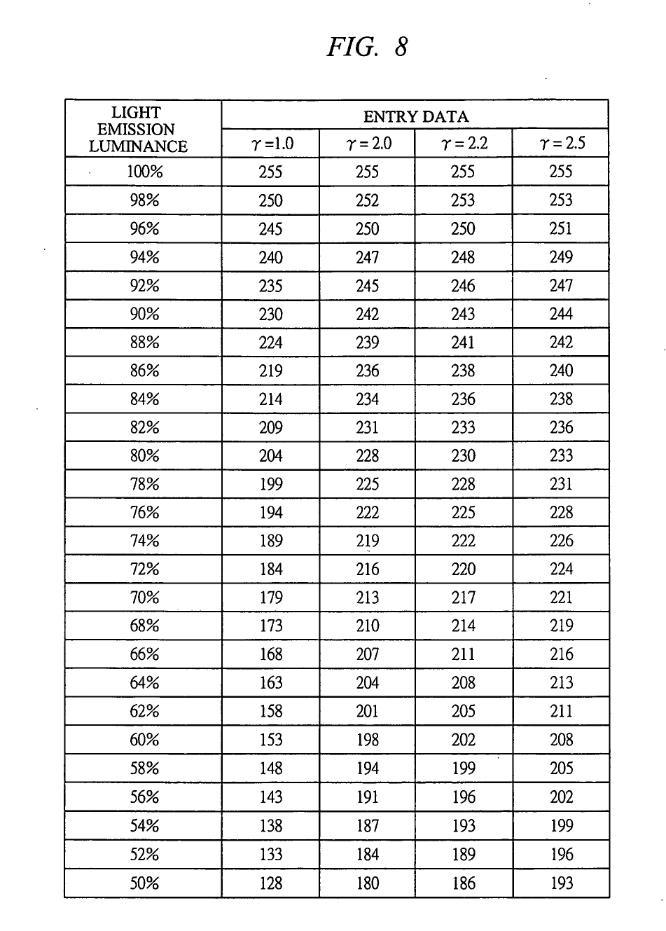

The entry data generating circuit 602 is a block that generates entry data, on the basis of the input maximum value 607, minimum value 608 of the backlight emission amount (luminance). The entry data shows the display data of each analysis area in a histogram. In the present embodiment, for example the portion between the maximum value 607 and the minimum value 608 is divided into 16, and entry data equivalent to each light emission luminance is generated. Herein, the relation of the light emission luminance and the entry data is not linear in general, but is equivalent to the relation of the display luminance and the display data, that is, so-called gamma curve. Therefore, as shown in FIG. 8, by the difference of a gamma value (γ) (example: 1.0, 2.0, 2.2, 2.5), the value of the entry data to the light emission luminance (example: 50˜100%) is different. Accordingly, in the third embodiment, in the histogram counting circuit 601, in addition to the maximum value 607 and the minimum value 608 of the backlight emission amount, the gamma value 609 is input, and the entry data is automatically generated internally. This action can be easily realized by use of a lookup table or the like. Thereby, it can be easily applied to display panels with different gamma values (609). Meanwhile, in the present structure, if several kinds of the gamma values 609 are prepared, and selection is made from them, it is possible to restrict the increase of the circuit scale.

The comparator A 603 compares the entry data input from the entry data generating circuit 602, and the display data (d) 208, and for example when the display data (d) 208 is larger, it outputs “1”, meanwhile when the display data is smaller, it outputs “0”.

The counter 604 is reset when the frame SYNC 209 gets on, and accumulatively adds the result output of the comparator A 603 per entry, until the frame SYNC 209 becomes on again.

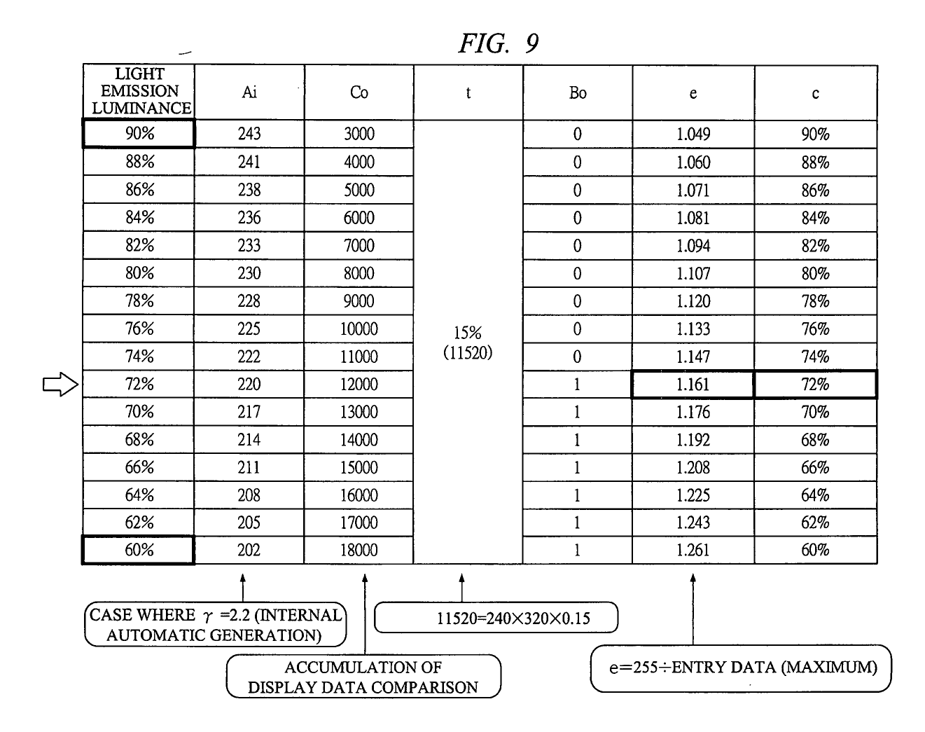

FIG. 9 shows, concerning the counter 604, an example of accumulative addition result to a certain image, in the case where the maximum value (607) of the light emission luminance: 90%, minimum value (608): 60%, and gamma value (609): 22, on the basis of FIG. 8. Meanwhile, in the table, Ai denotes the entry data of the comparator A 603 (in the case when γ=2.2), Co denotes the output of the counter 604, t does the threshold value 210, Bo does the output of the comparator 605, e does the display data expansion coefficient 610, and c denotes the backlight adjustment coefficient 611.

The comparator B 605 compares the output (Co) of the counter 604 and the threshold value (t) 210, and for example when the threshold value (t) 210 is larger, it outputs “0”, meanwhile when the threshold value is smaller, it outputs “1”. Herein, the threshold value (t) 210 is input for example in form of M%, and the value to be used actually in the calculation is made the number of all the pixels in the screen×M%. In the example in FIG. 9, it is supposed that the resolution is (240×320) pixels, and the threshold value (t) 210 is 15%, and the value used in the actual calculation in this case is 11520 (=240×320×0.15). Accordingly, the light emission luminance is 72% (entry data (Ai):220) and the accumulative count value exceeds 11520, and in the entry below this, the output (Bo) of the comparator B 605 becomes “1”.

The coefficient generating circuit 606, while the comparator B 605 outputs “1”, selects the largest entry data as the selection data value (Ds) 212, and performs a calculation (255÷selection data value (Ds)), and outputs the result as the display data expansion coefficient (e) 610. Herein, if all the comparators B 605 output “0”, the minimum entry data is selected. Further, the light adjustment luminance information in the entry is output as it is as the backlight adjustment coefficient (c) 611. In the example in FIG. 8, since the maximum value of the entry data (Ai) to which the comparator B 605 outputs “1” is 220, the display data expansion coefficient (e) 610 becomes 255/220=1.128, and the backlight adjustment coefficient (c) 611 becomes 72%. Meanwhile, the display data expansion coefficient (e) 610 is equivalent to the display data expansion coefficient (e) 213 shown in FIG. 2, and the backlight adjustment coefficient (c) 611 is equivalent to the backlight voltage selection signal (Sv) 215 shown in FIG. 2, or the backlight control signal 502 shown in FIG. 5. Herein, when the backlight adjustment is realized by pulse width modulation, since the relation of the pulse width and the light adjustment ratio is generally linear, the backlight adjustment coefficient (c) 611 may be made the duty of the pulse width as it is. Even if the relation of the pulse width and the light adjustment is not linear, it can be easily realized by a conversion using a lookup table.

The histogram counting circuit 601 in the above third embodiment enables a further more flexible backlight control by inputting four kinds of parameters, that is, the maximum value 607 of the backlight emission amount, the minimum value 708, the threshold value (t) 210, and the gamma value 609. For example, in the first embodiment, when a white display is made on the entire screen, the backlight emission amount becomes 100%, on the other hand, in the third embodiment, it becomes a light emission amount according to the maximum value 607 of the backlight emission amount, for example, when the maximum value 607 is set to 90%, the backlight emission amount becomes 90%. Meanwhile, when the backlight emission amount is 90%, although the screen brightness itself becomes darker than the case when the backlight emission amount is 100%, the power consumption concerning the backlight emission decreases. Accordingly, even when an image full of bright data is displayed, it is possible to expand the free degree of selection according to the priority of image quality or power consumption.

Meanwhile, it is desirable that the above respective parameters can be memorized in the control register 103, and can be rewritten from the control processor 114 of the outside. Further, if the maximum value 607 and the minimum value 608 are set to a same value, it is possible to realize the constant value (k) 202 shown in FIG. 2. Furthermore, in the present third embodiment, by the setting of the gamma value 609, it is applicable also to a display panel having different gamma values, but in the case of use a display panel (liquid crystal panel 115) that does not fit the curve of the gamma value, for example 16 pieces of entry data shown in FIG. 8 are all registered, and can be set individually from the control processor 114.

Further, in the present embodiment, in FIG. 9, with regard to the value (Ai) of the entry of the comparator A 603, the interval (one division to become a unit to take a histogram) is 2 or 3. This is the optimized value as the results obtained by experiments, and if this interval is made wider, in concrete when it is made 8 or higher, the difference of the backlight emission luminance becomes large. And, there occurs a flicker, causing a problem in display. Accordingly, the interval of the value (Ai) of the entry of the comparator A 603 is preferably 8 or below.

### Fourth Embodiment

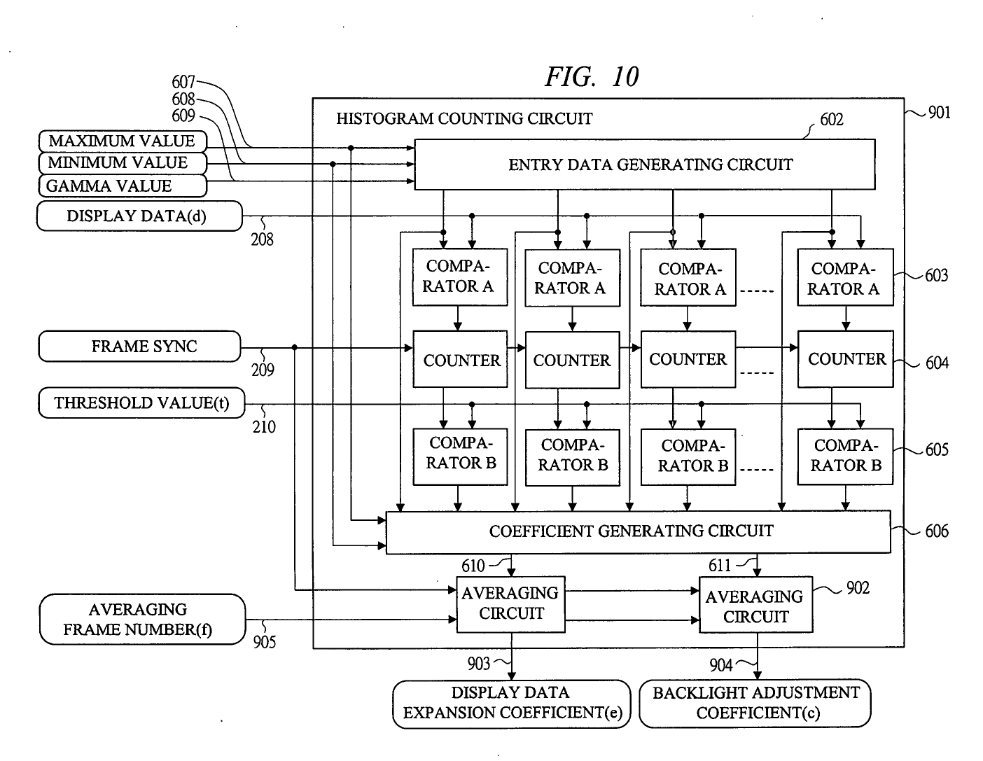

Next, a fourth embodiment is explained with reference to FIG. 10 hereinafter. In the first through third embodiments, the light emission amount of the backlight is controlled per one frame. However, when the light emission amount fluctuates rapidly per frame, there is a possibility that a flicker may occur. Accordingly, in a liquid crystal driver according to the present fourth embodiment, the light emission amount of the backlight is determined on the basis of the average value of plural frames, and thereby a flicker is prevented from occurring.

FIG. 10 shows a block structure of a histogram counting circuit 901 (circuit corresponding to the 201) for realizing the fourth embodiment. The histogram counting circuit 901 is of the same structure as that of the histogram counting circuit 601 according to the third embodiment shown in FIG. 7, except of an averaging circuit 902. Accordingly, the action of the averaging circuit 902 is explained hereinafter.

The averaging circuit 902 holds the display data expansion coefficient (e) 610 and the value of the backlight adjustment coefficient (c) 611, input from the coefficient generating circuit 606, for the past f frames (f being a positive integer), and by dividing the sum of these by f, generates and outputs a new display data expansion coefficient (e) 903 and backlight adjustment coefficient (c) 904. Herein, it is preferable that the value of f is registered by the name of an averaging frame number 905, and can be rewritten from the control processor 114. Meanwhile, if the value of f is too large, there is an adverse effect that the response of the light emission control becomes slow, therefore, it is preferable that it is set in 16˜64 frames.

According to the histogram counting circuit 901 in the fourth embodiment, the light emission amount of the backlight is determined on the basis of the average value of plural frames, the rapid change of the light emission luminance is eased, and the occurrence of flicker can be prevented.

### Fifth Embodiment

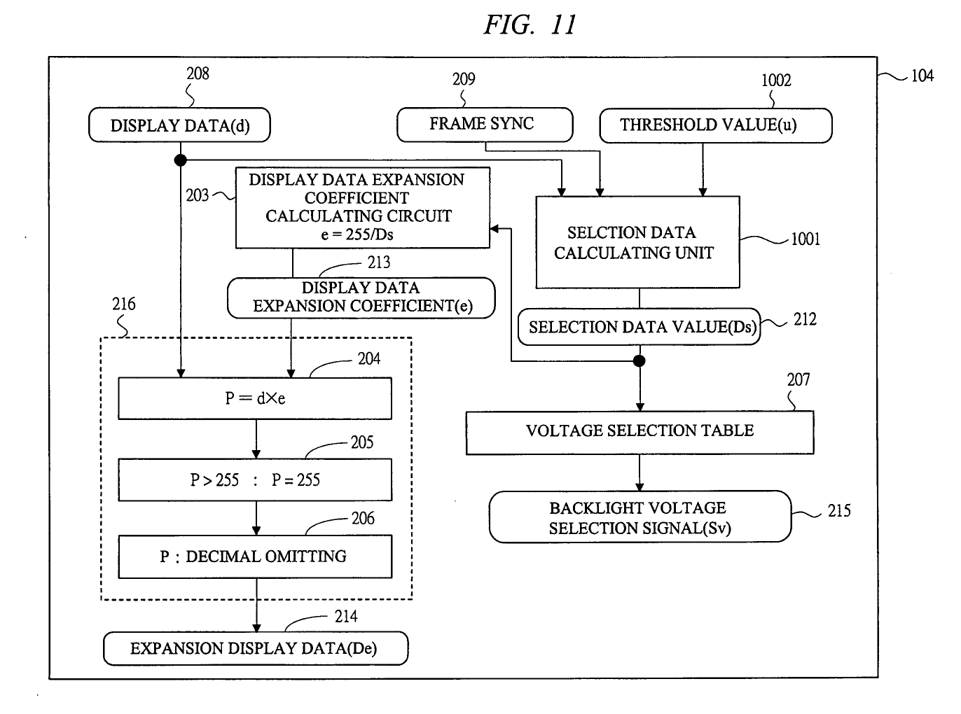

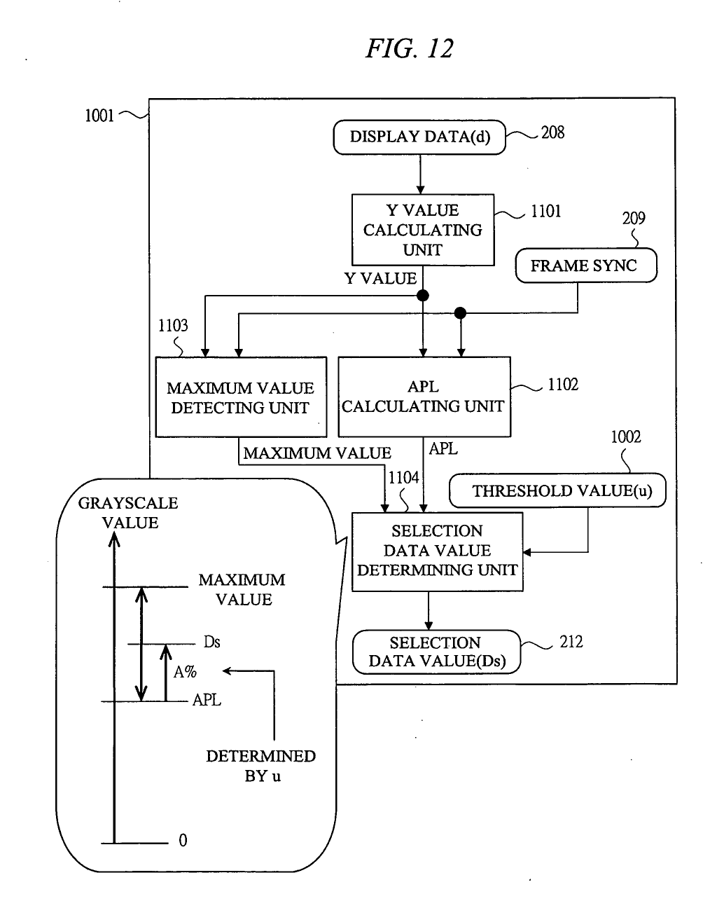

Next, a fifth embodiment is explained with reference to FIG. 11 through FIG. 12 hereinafter. The structure of the backlight control circuit 104 in FIG. 11 is the portion corresponding to FIG. 2 in the first embodiment, meanwhile the histogram counting unit 201 is replaced with a selection data value calculating unit 1001. In the fifth embodiment, the calculation method of the selection data value (Ds) 212 to replace the method using the histogram of the first embodiment is explained.

FIG. 12 shows an internal block structure of the selection data value calculating unit 1001. The selection data value calculating unit 1001 has a Y value calculating unit 1101, an APL calculating unit 1102, a maximum value detecting unit 1103, and a selection data value determining unit 1104. The selection data value calculating unit 1001 inputs a threshold value (ta) 1002.

In the Y value calculating unit 1101, from R (red), G (green), B (blue) sub pixel data of input display data (d) 208, a Y value to become the luminance value of the display data is calculated. In the APL calculating unit 1102, the value obtained by averaging the Y value by one frame is output as the APL (Average Picture Level: average luminance level). In the maximum value detecting unit 1103, by use of the Y value too, the maximum value (maximum luminance value) for one frame is obtained and output. In the selection data value determining unit 1104, by use of the APL and the maximum value, the selection data value (Ds) 212 of the frame is determined. In this determination method, the value at the portion of a specified % (A%) from the APL side toward the maximum value side, between the maximum value and the APL, in the grayscale value of the display data (d) 208 is determined as the selection data value (Ds) 212. This A is determined by the threshold value (u) 1002. As explained above, in the present embodiment, the selection data value (Ds) 212 is calculated without using histogram counting, and the same function can be realized.

### Sixth Embodiment

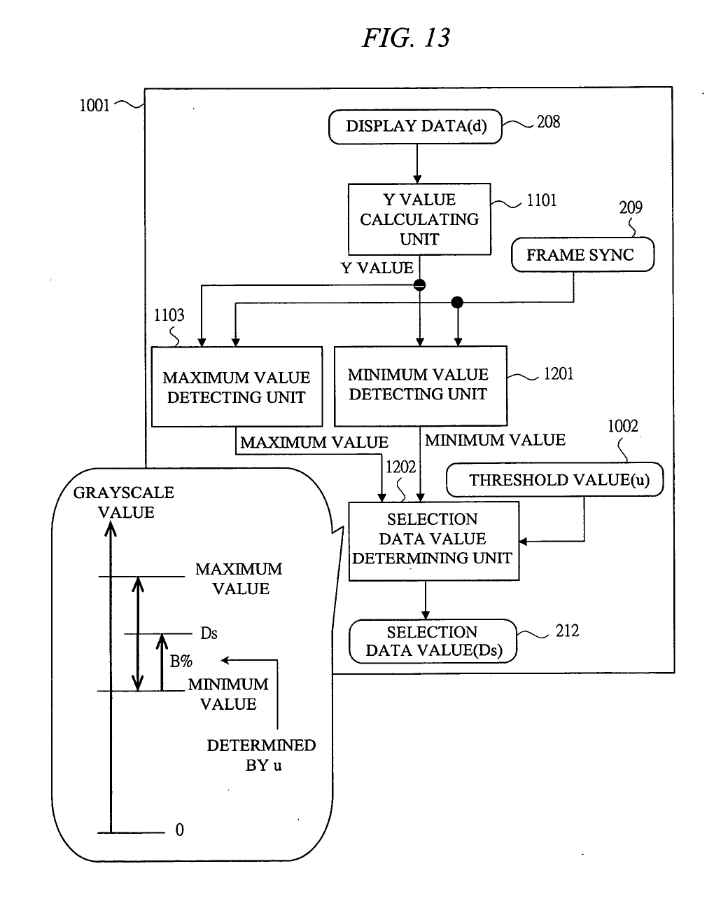

Next, a sixth embodiment is explained with reference to FIG. 11 and FIG. 13 hereinafter. In the sixth embodiment, the structure of the selection data value calculating unit 1001 in FIG. 11 is different from that in the fifth embodiment. FIG. 13 shows the structure of the selection data value calculating unit 1001 in the sixth embodiment. This structure, in comparison with the structure in FIG. 12 of the fifth embodiment, has a minimum value detecting unit 1201 in the place of the APL calculating unit 1102, and there is a change in the selection data value determining unit 1104. In the sixth embodiment, the method for calculating the selection data value (Ds) 212 by use of the maximum value and the minimum value of the Y value of frame is explained hereinafter.

In the minimum value detecting unit 1201, the minimum value is obtained from the Y value for one frame and output. In the selection data value determining unit 1202, the value at the portion of a specified % (B%) from the minimum value side toward the maximum value side, between the maximum value and the minimum value is determined as the selection data value (Ds) 212. This B is determined by the threshold value (u) 1002. As explained above, in the present embodiment, the selection data value (Ds) 212 is calculated from the maximum value and the minimum value, and the same function can be realized.

### Seventh Embodiment

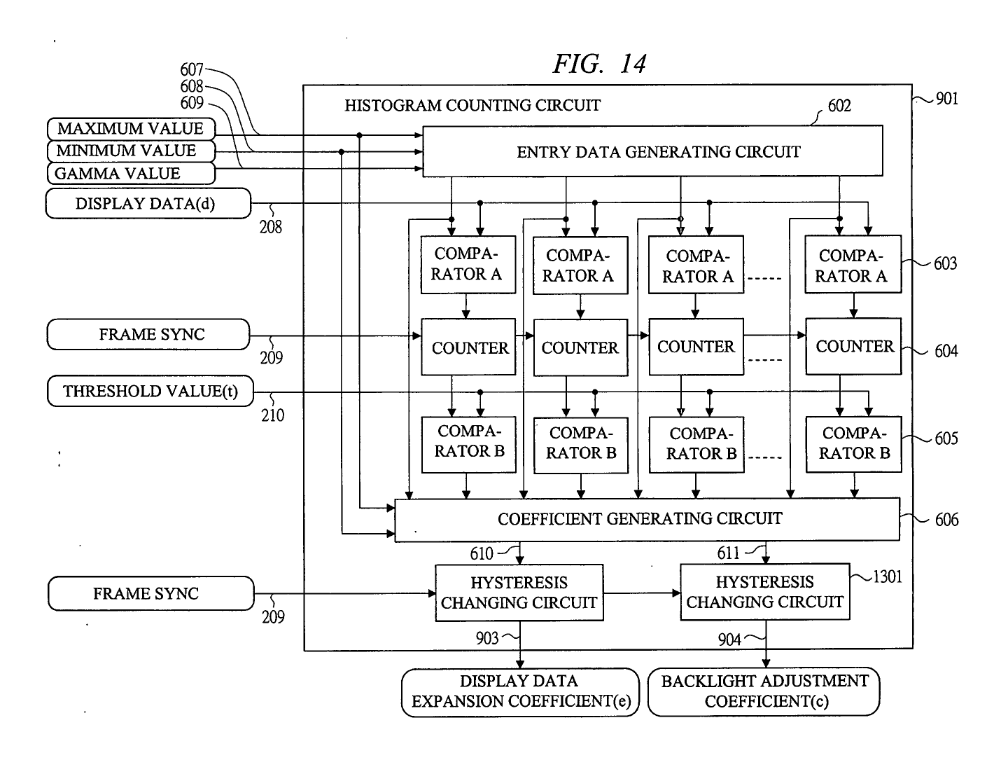

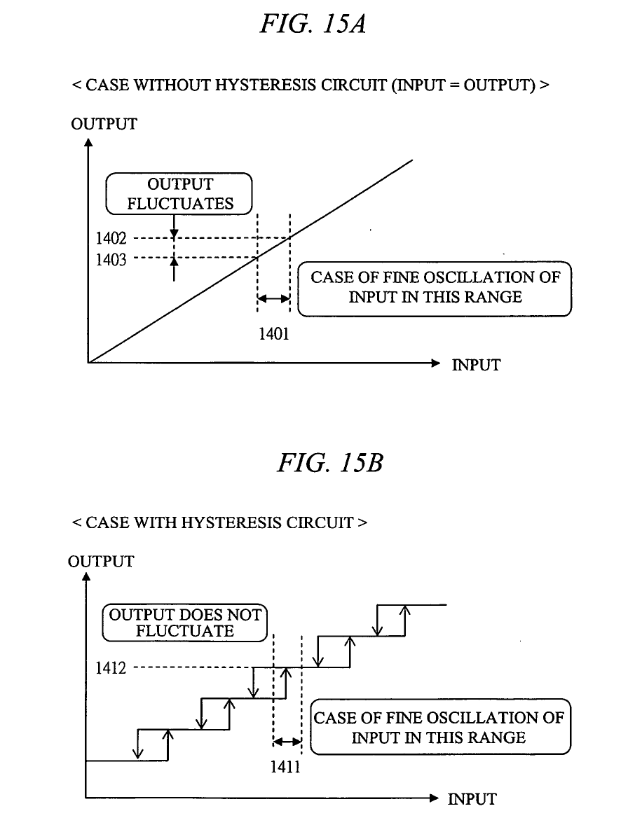

Next, a seventh embodiment is explained with reference to FIG. 14 and FIG. 15 hereinafter. The structure of the histogram counting circuit 901 in FIG. 14 is a replacement of the structure in FIG. 10 of the fourth embodiment, and the averaging circuit 902 is replaced with a hysteresis changing circuit 1301.

In the structure of the histogram counting circuit 901 in FIG. 14, in order for generated coefficients (610, 611) not to appear as flickers when oscillating finely, hysteresis (well-known hysteresis control) is added to the change, and thereby reciprocation around the threshold value is prevented.

In FIG. 15, the effect of adding the hysteresis is explained. FIG. 15A shows the relation in the case where there is no hysteresis means (hysteresis changing circuit 1301), that is, the case where input is equal to output. When the input oscillates finely (for example, when the input oscillates finely at the range 1401), the output oscillates (oscillates at the value 1402 and the value 1403). FIG. 15B shows the case where there is hysteresis means (hysteresis changing circuit 1301) as shown in FIG. 14. Even when the input oscillates finely at a certain range (for example the range 1411), the output becomes constant (value 1412) by hysteresis. By this effect, it is possible to prevent flickers owing to fine oscillation of the generated coefficients (610, 611).

### Eighth Embodiment

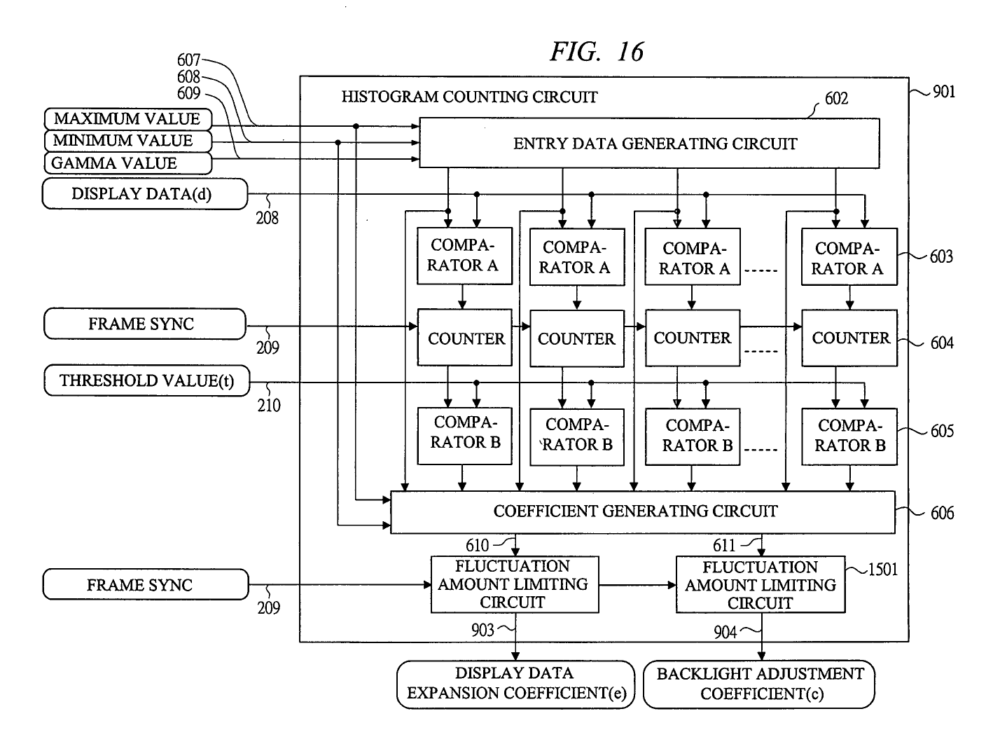

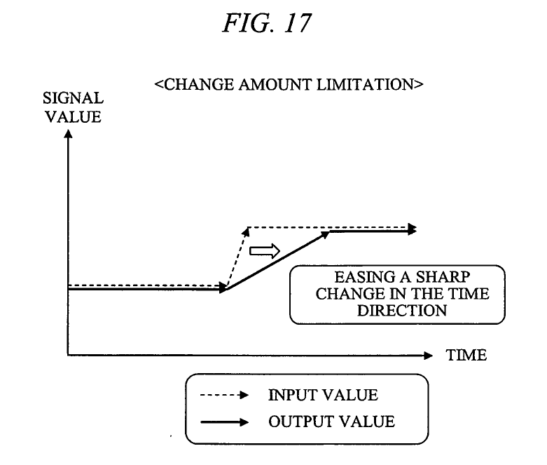

Next, an eighth embodiment is explained with reference to FIG. 16 and FIG. 17 hereinafter. The structure of the histogram counting circuit 901 in FIG. 16 is a replacement of the structure in FIG. 10 of the fourth embodiment, and the averaging circuit 902 is replaced with a fluctuation amount limiting circuit 1501. In the histogram counting circuit 901, this fluctuation amount limiting circuit 1501, when the generated coefficients (610, 611) fluctuate rapidly, works so as to ease the fluctuation in the time direction.

In FIG. 17, the action of the fluctuation amount limiting circuit 1501 is explained. The dot line arrow shows an input value, and the full line arrow shows an output value. The fluctuation amount limiting circuit 1501, even when the input value increases sharply, expands the change in the time direction, and the output value increases moderately. Further, although not illustrated therein, the same process is made in the case of a sharp decrease. By such a structure, according to the present embodiment, it is possible to prevent flickers owing to a sharp fluctuation.

### Ninth Embodiment

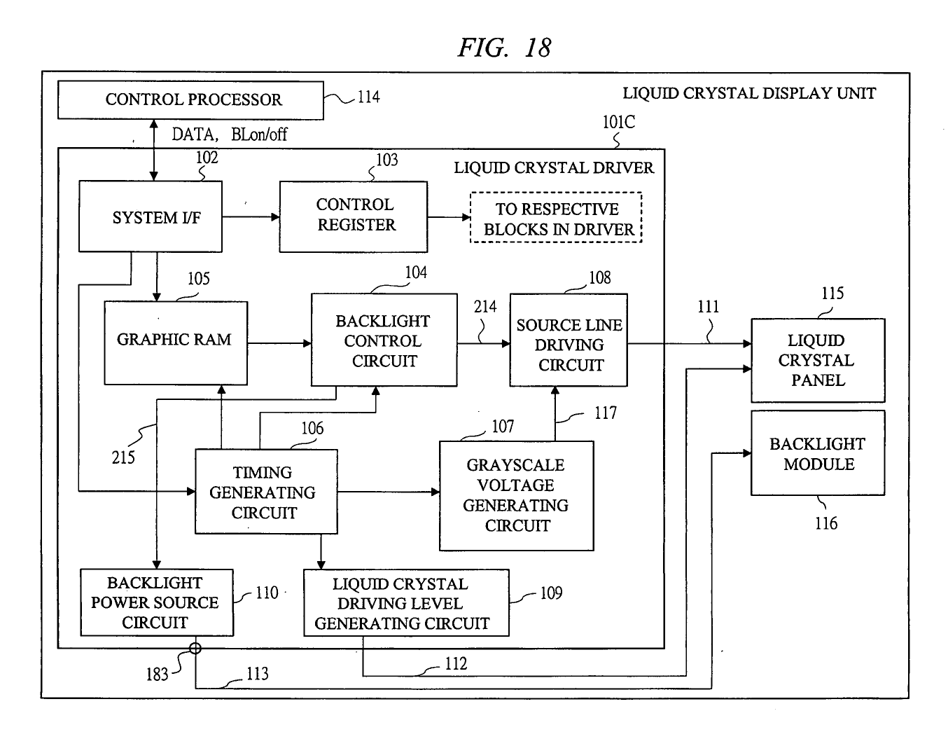

Next, a ninth embodiment is explained with reference to FIG. 18 hereinafter. In the structure of the liquid crystal driver 101C in FIG. 18, in comparison with the structure in FIG. 1 of the first embodiment, the positions of the backlight control unit 104 and the graphic RAM 105 are changed. In FIG. 18, the graphic RAM 105 is connected just after the system I/F 102, and the display data is written from the system I/F 102 directly into the graphic RAM 105. And, just after reading the display (output to the panel), it goes through the backlight control unit 104, and the display data expansion processing and the generation of the backlight power source voltage control signal are performed. Thereby, the expanded display data (214) is sent to the source line driving circuit 108, and the backlight power source voltage control signal (215) is sent to the backlight power source circuit 110.

In the structure of the first embodiment, in writing the display data from the system I/F 102, all the data to be displayed must be written per frame. On the other hand, in the structure of the present embodiment, random access is available in writing from the system I/F 102.

Further, the liquid crystal driver 101C has a terminal 183 that is connected to the backlight power source line (backlight voltage) 113 to the backlight module 116, at the rear stage of the backlight power source circuit 110.

### Tenth Embodiment

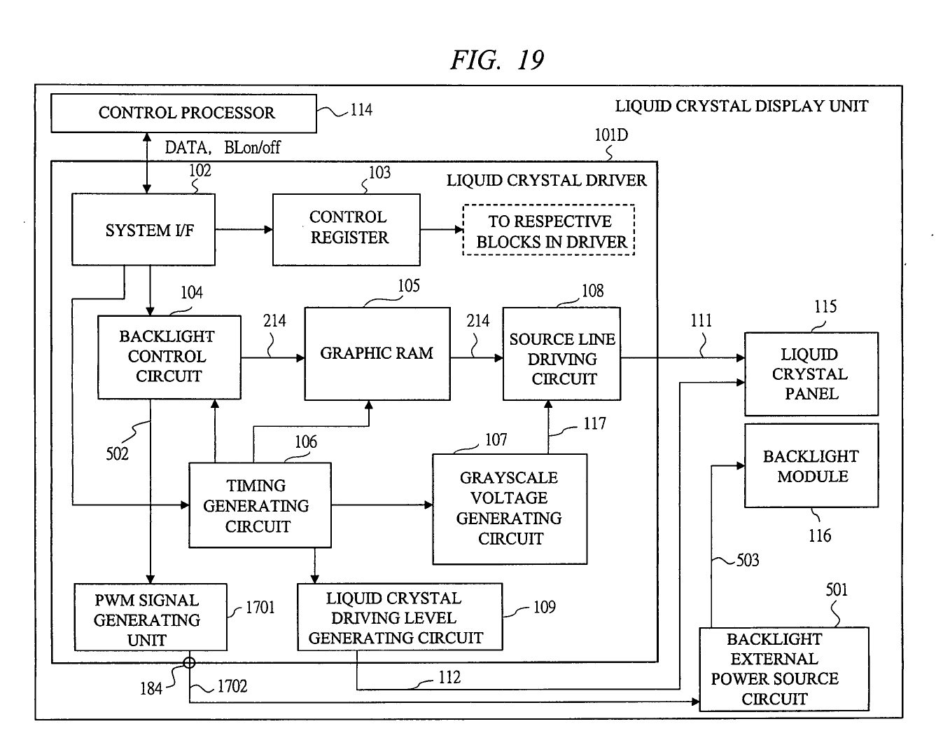

Next, a tenth embodiment is explained with reference to FIG. 19 hereinafter. In the structure of the liquid crystal driver 101D in FIG. 19, in comparison with the structure in FIG. 5 of the second embodiment, a PWM (pulse width modulation) signal generating unit 1701 is added at the rear stage of the backlight control circuit 104. From the PWM signal generating unit 1701 to the backlight external power source circuit 501, a backlight control PWM signal 1702 is output. The PWM signal generating unit 1701 receives information (502) for the control of voltage (503) generated by the backlight external power source circuit 501, output from the backlight control unit 104, and converts this into a signal of pulse width modulation (PWM). Then, it sends this signal as a backlight control PWM signal 1702, to the backlight external power source circuit 501. By making it the signal (1702) of pulse width modulation in this manner, when the information (502) of voltage is sent directly as in the structure in FIG. 5, four or more signal lines are needed (for example, in the case of 16-stape voltage control), but the number of lines can be reduced to one. Furthermore, the fine adjustment of the voltage (503) to the backlight module 116 can be made by the fine adjustment of pulse width, as a consequence, the fine adjustment can be made at the side of the liquid crystal driver 101. In other words, there is no need for the fine adjustment by the backlight external power source circuit 501.

Further, the liquid crystal driver 101D has a terminal 184 connected to the signal line of the backlight control PWM signal 1702 to the backlight external power source circuit 501, at the rear stage of the PWM signal generating unit 1701.

The embodiments described heretofore can be applied to not only a liquid crystal display unit, but also other display units including an organic EL display unit and a plasma display unit and the like. Further, above explanations have been made with the case using a histogram of pixel values, however, the same object can be realized by use of the distribution concerning histogram, statistic data and the like.

Furthermore, as an illumination means, the illumination structure by a backlight has been explained as a general and simple structure as shown in FIG. 6, however, a more complicated structure, for example illumination by plural lights may be used, and it is not limited to the structure of illumination from the rear surface of the display panel. Moreover, the unit of display data processing corresponding to the histogram is not limited to one frame image corresponding to the display panel surface, but plural frames may be used as a unit, or, another embodiment may be employed where the control is made in the same manner with blocks or the like into which a frame is divided as a unit.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention may be applied to various display units. Especially, the embodiments described above, where the method to control a backlight and attain power saving can be packaged with a restrained logic amount, may be applied to not merely liquid crystal displays for cell phones, but also various information devices including compact media players and the like such as DVDs and the like using liquid crystal displays.

What is claimed is:

1. A display driving circuit for driving a display panel according to input display data, the circuit comprising
a first circuit that, with a display data value at the first position of the significant of a histogram of the input display data as a standard value, switches the brightness of a display image by conversion of the display data on the basis of the standard value,
a second circuit that switches the brightness of an illumination device that illuminates the display panel on the basis of the standard value,
a third circuit that detects and holds the histogram on the basis of the input display data, and
a control circuit that, on the basis of the standard value in the detected histogram, makes large the brightness of the display image by the first circuit, and makes small the brightness of the illumination device in correspondence to the brightness of the display image by the second circuit, wherein
the objective that the third circuit detects and holds the histogram is the partial range corresponding to the portion from the most significant position to the second position to become the lower limit.

2. A display driving circuit according to claim 1, wherein
the second position is limited from the most significant at a specified rate.

3. A display driving circuit according to claim 1, wherein
the second position is limited from the most significant at a specified number.

4. A display driving circuit according to claim 1, wherein
the control circuit, in the detected histogram and the standard value, when there is included the standard value below the partial range of the histogram, uses the value corresponding to the second position to become the lower limit of the partial range as the standard value.

5. A display driving circuit according to claim 1, further comprising
a circuit that sets and changes the value of the second position from an external device of the display driving circuit.

6. A display driving circuit according to claim 1, further comprising
a circuit that changes settings from an external device of the display driving circuit, so that the use of the histogram is stopped temporarily, and a constant value k is used in place of the standard value.

7. A display driving circuit according to claim 1, further comprising
a circuit that turn on/off the illumination device from an external device of the display driving circuit, wherein
the control of turning on/off the illumination device from the external device has priority over the control of the brightness of the illumination device by the control circuit.

8. A display driving circuit according to claim 1, further comprising
a power source circuit that supplies voltage to the illumination device, wherein
the control circuit outputs a signal for selecting the voltage to the illumination device, to the power source circuit.

9. A display driving circuit according to claim 1, wherein
the display driving circuit is connected to an external power source circuit that supplies voltage to the illumination device,
the control circuit outputs a signal for selecting the voltage to the illumination device, to the external power source circuit.

10. A display driving circuit according to claim 1, wherein
the display panel is a liquid crystal panel,
the illumination device is a backlight that is arranged at the rear surface side of the liquid crystal panel, and according to the lighting state of the backlight, illuminates from the backlight surface to the liquid crystal panel surface, and
the second circuit changes the voltage to the backlight, thereby changes the light emission ratio in the lighting state of the backlight.

11. A display driving circuit for outputting voltage according to display data input from an external device to a display panel, the circuit comprising
a measuring circuit that measures a histogram on display data for one or plural screens input from the external device, and detects a data value of the histogram corresponding to specified display data,
a converting circuit that converts display data for the one or plural screens, according to the data value of the histogram corresponding to the specified display data,
a generating circuit that generates plural voltages according to the values of plural display data,
a selecting circuit that selects the voltage according to the display data after the conversion from the plural voltages, and
a setting circuit that sets the range to measure the histogram.

12. A display driving circuit according to claim 11, wherein
the measuring circuit, when the specified display data is out of the range of the histogram set by the setting circuit, detects the value of the border of the range of the histogram, and
the converting circuit converts the display data for the one or plural screens, according to the value of the border of the range of the histogram.

13. A display driving circuit according to claim 11, wherein
the range to measure the histogram is the partial range of the value of the third position or more in the display data, and the value of the third position is larger than the minimum value of the display data and smaller than the maximum value thereof.

14. A display driving circuit according to claim 11, wherein
the display panel is equipped with an illumination device that illuminates pixels, and
according to the data value of the histogram corresponding to the specified display data, the voltage to the illumination device or the light emission amount of the illumination device is controlled.

15. A display driving circuit for driving a display panel according to input display data, the circuit comprising
a circuit that switches the brightness of a display image, on the basis of the display data value at the position of the significant P% (P being a positive real number) from the bright side of the input display data, and
a circuit that switches the brightness of a backlight to the display panel on the basis of the display data, wherein
the range from the display data corresponding to the significant Q% (Q being a positive real number) from the bright side of the display luminance, to the display data corresponding to R% (R being a positive real number, and R≦Q) is made as image histogram analysis range for detecting the P%, and
when the P is larger than the Q, the switching amount of the luminance of the backlight and the brightness of the display image is same as that corresponding to the data at the position of the Q, and when the P is smaller than the R, the switching amount of the luminance of the backlight and the brightness of the display image is same as that corresponding to the data at the position of the R.

16. A display driving circuit according to claim 15, further comprising
a circuit that sets and changes the respective values of the P, Q, and R, from an external device of the display driving circuit.

17. A display driving circuit according to claim 15, wherein
the display data corresponding to the significant Q% from the bright side of the display luminance, and the display data corresponding to the R% are changed according to a gamma curve that the display panel has, and further comprising
a circuit that sets and changes information concerning the gamma curve from an external device of the display driving circuit.

18. A display driving circuit according to claim 15, further comprising
a circuit that turn on/off the backlight from an external device of the display driving circuit, wherein
the control of turning on/off the backlight from the external device has priority over the switching the luminance of the backlight.

19. A display driving circuit according to claim 15, wherein
the value of the P is determined on the basis of the average value of histogram analysis results over plural frames of the display image, and further comprising
a circuit that sets and changes the number of frames required for calculating the average value, from an external device of the display driving circuit.

20. A display driving circuit according to claim 15, wherein
the range of one area to take a histogram in the image histogram analysis range from the Q to the R is 8 or below in grayscale value.

21. A display driving circuit for outputting voltage according to display data input from an external device to a display panel, the circuit comprising
a measuring circuit that obtains an APL (average picture level) and the maximum luminance value of display data for one or plural screens input from the external device, and outputs the value at the portion of A% from the APL between these values,
a converting circuit that converts display data for the one or plural screens, according to the value at the portion of the A%,
a generating circuit that generates plural voltages according to the values of plural display data, and
a selecting circuit that selects the voltage according to the display data after the conversion from the plural voltages.

22. A display driving circuit according to claim 21, wherein
the display panel is equipped with an illumination device that illuminates pixels, and
according to the value at the portion of the A%, the voltage to the illumination device or the light emission amount of the illumination device is controlled.

23. A display driving circuit for outputting voltage according to display data input from an external device to a display panel, the circuit comprising
a measuring circuit that obtains the values of the minimum luminance and the maximum luminance of display data for one or plural screens input from the external device, and outputs the value at the portion of B% from the minimum luminance value between these values,
a converting circuit that converts display data for the one or plural screens, according to the value at the portion of the B%,
a generating circuit that generates plural voltages according to the values of plural display data, and
a selecting circuit that selects the voltage according to the display data after the conversion from the plural voltages.

24. A display driving circuit according to claim 23, wherein
the display panel is equipped with an illumination device that illuminates pixels, and
according to the value at the portion of the B%, the voltage to the illumination device or the light emission amount of the illumination device is controlled.

25. A display driving circuit according to claim 15, further comprising
a hysteresis changing circuit that prevents output from fluctuating to fine fluctuation changes of input, at the output side of a circuit that counts the image histogram analysis range, and
the value of the P is determined on the basis of the output of the hysteresis changing circuit.

26. A display driving circuit according to claim 15, further comprising
a fluctuation amount limiting circuit that eases changes in the time direction even to sharp changes of input, at the output side of a circuit that counts the image histogram analysis range, and
the value of the P is determined on the basis of the output of the fluctuation amount limiting circuit.

27. A display driving circuit according to claim 1, wherein
a memory that stores the display data is built in, and
the first, second, third circuits that control the switching amount of brightness of the display image and the illumination device, and a control circuit corresponding to the control circuits are connected to the display read side of the memory.

28. A display driving circuit according to claim 14, wherein
a pulse width modulation signal is used for controlling the voltage to the illumination device or the light emission amount of the illumination device.

29. A display driving circuit according to claim 14, further comprising
a terminal that outputs the voltage to be output to the illumination device or a control signal.
